(19) United States
(12) Patent Application Publication
(10) Pub. No.: US 2025/0131458 A1
(43) Pub. Date: Apr. 24, 2025

(54) SENSITIVE SURROGATE METRICS IDENTIFICATION

(71) Applicant: Tencent America LLC, Palo Alto, CA (US)

(72) Inventor: Yang SU, San Francisco, CA (US)

(73) Assignee: Tencent America LLC, Palo Alto, CA (US)

(21) Appl. No.: 18/381,978

(22) Filed: Oct. 19, 2023

(51) Int. Cl. G06Q 30/0201

(52) U.S. Cl. CPC G06Q 30/0201

(57) ABSTRACT

The disclosure includes methods and an apparatus that includes processing circuitry that selects at least one candidate surrogate metric from a plurality of surrogate metrics based on first testing data of a target metric and the plurality of surrogate metrics from a first database in memory. The first testing data have been generated from previously controlled testing of a control variant and a treatment variant of a feature of a webpage or a computer application. The processing circuitry determines current testing results associated with the plurality of surrogate metrics and determines an output of the current controlled testing based on one or more of the current testing results associated with the at least one candidate surrogate metric. If the output indicates the treatment variant replacing the control variant of the feature of the webpage or the computer application, the control variant is replaced with the treatment variant of the feature.

### TECHNICAL FIELD

The present disclosure describes aspects generally related to intelligent surrogate recommendation for controlled customer reaction experiment.

### BACKGROUND

Improvements to various aspects of webpages, websites, and computer applications that improve visibility, usability, or aesthetics often lead to an enhanced user experience and higher user engagement. However, it is sometimes unclear how changes to the various aspects of the webpages and the computer applications will affect the user experience. While testing among the various options for the websites or computer applications may be used to determine which option is better received by users, it is important to generate an optimal testing strategy so that the testing results efficiently indicate desirable options for the website or computer application.

A/B testing can be used to compare multiple versions of a feature such as an element of a web page, a web page, an element of a computer application, a computer application, or the like, by testing users responses to variant A (e.g., yellow color) against variant B (e.g., blue color) of a feature (e.g., a headline of a web page), and determining which of the variants is more effective (e.g., which variant results in more user engagement with the web page). In an example, the more effective variant can be used in the feature, e.g., the headline of the web page uses the blue color.

The background description provided herein is for the purpose of generally presenting the context of the disclosure. Work of the presently named inventor, to the extent the work is described in this background section, as well as aspects of the description that may not otherwise qualify as prior art at the time of filing, are neither expressly nor impliedly admitted as prior art against the present disclosure.

### SUMMARY

Aspects of the disclosure provide an improvement in website and computer application design by identifying surrogate metric(s) that are good and sensitive indicators of user experience or engagement. This identification selects the surrogate metric(s) by using past experiment data that have been measured in previous controlled experiments in order to more efficiently conduct user testing that yields user response results that are more accurate than related technologies without enlarging the amount of testing data needed.

Aspects of the disclosure include methods and an apparatus. In some examples, the apparatus includes processing circuitry configured to selecting at least one candidate surrogate metric from a plurality of surrogate metrics based on first testing data of a plurality of metrics from a first database in memory. The first testing data have been generated from previously controlled testing of different test variants. The plurality of metrics includes a target metric and the plurality of surrogate metrics that is indicative of the target metric. The previously controlled testing has been performed with first users. The different test variants include a control variant and a treatment variant of a feature of a webpage or a computer application. The processing circuitry performs current controlled testing of the different test variants with second users by obtaining second testing data of the plurality of metrics for the current controlled testing and storing the second testing data in a second database in the memory, and determining current testing results that are associated with the plurality of surrogate metrics. The processing circuitry determines an output of the current controlled testing based on one or more of the current testing results associated with the at least one candidate surrogate metric. The output of the current controlled testing indicates whether the treatment variant replaces the control variant of the feature of the webpage or the computer application. In response to the output indicating that the treatment variant replaces the control variant of the feature of the webpage or the computer application, the processing circuitry replaces the control variant of the feature with the treatment variant.

In an aspect, the processing circuitry is configured to obtain first testing data of a plurality of metrics from a database in memory. The first testing data have been generated from previously controlled testing of different test variants. The plurality of metrics includes a target metric and a plurality of surrogate metrics that is indicative of the target metric. The different test variants include a control variant and a treatment variant of a feature of a webpage or a computer application. The processing circuitry determines, based on the first testing data, correlations between each of the plurality of surrogate metrics and the target metric and determines candidate surrogate metrics from the plurality of surrogate metrics based on the determined correlations. The processing circuitry determines a plurality of sensitivities of the respective candidate surrogate metrics based on the first testing data. A sensitivity of one of the candidate surrogate metrics indicates a probability that a change of the feature of the webpage or the computer application from the control variant to the treatment variant induces an effect that is detected as a statistically significant change in the one of the candidate surrogate metrics. The processing circuitry selects at least one candidate surrogate metric from the candidate surrogate metrics based on the determined plurality of sensitivities. The at least one candidate surrogate metric is used to determine an output of a current controlled testing of the control variant and the treatment variant of the feature of the webpage or the computer application, and the output indicates whether the treatment variant replaces the control variant of the feature of the webpage or the computer application.

Aspects of the disclosure also provide a non-transitory computer-readable medium storing instructions which when executed by a computer cause the computer to perform the methods.

The apparatus including the processing circuitry that implements the methods of sensitive surrogate metrics identification and application and memory that stores the instructions, the past experiment data (e.g., the first testing data), the current experiment data (e.g., the second testing data), and the selected at least one candidate surrogate metric (e.g., the sensitive surrogate metrics) can significantly improve functions of the computer including improvement in website and computer application design. The methods include storing the past experiment data (e.g., the first testing data) in a database in the memory and accessing the memory to select sensitive surrogate metrics intelligently based on the past experiment data in the database. The sensitive surrogate metrics and/or the output of the current controlled experiment can be further displayed on a display device (e.g., a computer screen, a screen of a mobile device, or the like) to guide the website and computer application design. For example, the computer including the processing circuitry and the memory can increase the efficiency or the speed of the design due to the usage of the past experiment data stored in the memory. The computer including the processing circuitry and the memory can increase the accuracy of the determination of the output since the determination is based on the sensitive surrogate metrics that can indicate the effect of the treatment more accurately.

### BRIEF DESCRIPTION OF THE DRAWINGS

Further variables, the nature, and various advantages of the disclosed subject matter will be more apparent from the following detailed description and the accompanying drawings in which:

FIG. 1 shows an example of a flowchart of back-end computations according to an aspect of the disclosure.

FIGS. 2-3 show examples of frontend screenshots according to an aspect of the disclosure.

FIG. 4 shows an example of a system according to an aspect of the disclosure.

FIG. 5 shows a flowchart outlining a method according to an aspect of the disclosure.

FIG. 6 shows a flowchart outlining a method according to an aspect of the disclosure.

FIG. 7 is a schematic illustration of a computer system in accordance with an aspect of the disclosure.

### DETAILED DESCRIPTION

A controlled experiment such as A/B testing can be used to test multiple versions of at least one feature (or at least one variable) (e.g., an element of a web page, a web page, an element of a computer application, a computer application, or the like) on different user groups. An output of the controlled experiment can indicate which version is to be used for the feature. Two groups of user responses to a control version and a treatment version of a feature of a webpage or a computer application can be measured with a target metric (e.g., a retention rate of users of a computer game). However, if a difference between the two groups of user responses is relatively small compared to variances of the two groups of user responses, which version is to be used may be unclear. In an example, the feature is a color of a headline in a webpage, the controlled version is yellow color, and the treatment version is blue color. While the term “webpage” is used in this disclosure to refer to a document on the Internet, the disclosure may also apply to websites, which may include a collection of webpages linked under a common domain name. The improvements and methods described herein with respect to webpages are applicable to websites as well.

An aspect of the disclosure provides methods to identify surrogate metric(s) that are good indicators of the target metric and are highly sensitive, e.g., difference(s) between two groups of user responses measured with the respective surrogate metric(s) are relatively large compared to corresponding variances of the two groups of user responses. The methods can identify (e.g., select) the surrogate metric(s) by using past experiment data that have been measured in previous controlled experiments. As the past experiment data is already available prior to the controlled experiment (also referred to as a current controlled experiment), no new data is needed to perform the methods that identify the surrogate metric(s), and thus the methods can be applicable to new users, can be efficient (e.g., no need to collect the past experiment data in the current controlled experiment), and can be more accurate (e.g., sample sizes of the past experiment data can be relatively large) than related technologies.

Further, the surrogate metric(s) can be used to determine the output of the current controlled experiment, such as whether the treatment version or the control version of the feature of the webpage or the computer application is to be used. If the output indicates that the treatment version of the feature of the webpage or the computer application is to be used, the control version can be replaced by the treatment version of the feature, for example, the yellow color of the headline is replaced by the blue color of the headline.

The methods of sensitive surrogate metrics identification and application and memory that stores such instructions, the past experiment data, and the selected surrogate metrics can significantly improve functions (including improvement in website and computer application design) of a computer that implements the methods. The methods include storing the past experiment data in a database in the memory and accessing the memory to select the surrogate metrics intelligently based on the past experiment data in the database. The selected surrogate metrics and/or the output of a current controlled experiment can be further displayed on a display device (e.g., a computer screen, a screen of a mobile device, or the like) to guide the website and computer application design. For example, the computer that implements the methods can increase the efficiency or the speed of the design due to the usage of the past experiment data stored in the memory. The computer that implements the methods can increase the accuracy of the determination of the output since the determination is based on the selected surrogate metrics that can indicate the effect of the treatment more accurately.

A controlled experiment (also referred to as controlled testing) such as A/B testing can refer to a randomized experimentation process where multiple versions (also referred to as multiple variants) of at least one variable (or at least one feature) (e.g., an element of a web page, a web page, or the like) are shown to different user groups, for example, to determine which version is to be used based on a target metric (also referred to as a primary metric). The at least one feature can include a feature of a webpage or a computer application. A computer application can include a desktop application, a mobile application, a computer game, and the like. In an example, the target metric includes a North Star metric.

In an example, multiple versions of a variable (e.g., color of a headline in a web page) include a control version (e.g., yellow color) of the variable and a treatment version (e.g., a blue color) of the variable that is modified from the control version. The control version is only shown to users in a Group A, and the treatment version is only shown to users in a Group B. User responses including responses A to the control version and responses B to the treatment version can be obtained using the target metric. The user responses can be analyzed, for example, using statistical analysis to determine if the responses A from Group A and the responses B from the Group B are different (e.g., statistically different). In an example, the responses A and the responses B are statistically different and the responses B indicate more preferable responses than the responses A, and thus the treatment version can be selected.

In an example, when (i) the difference Δ between the responses A and the responses B increases (ii) and/or the variances (e.g., a variance σ_{C} of the responses A and a variance σ_{T} of the responses B) decrease, a more accurate determination as to whether the responses A are statistically different from the responses B may be made. In some examples, the difference Δ associated with the target metric is relatively small, and thus surrogate metrics that are indicative of the target metric can be used to measure the treatment effect in controlled testing to increase the difference Δ that can be measured.

The disclosure includes methods (e.g., sensitive surrogate metrics identification methods or surrogate metrics analysis and/or the implementation of the surrogate metrics analysis to determine an output of a controlled experiment) that can identify (or select) surrogate metric(s) that (i) can be highly correlated with the target metric (e.g., good indicators of the target metric) and (ii) can show high sensitivities to the treatment (e.g., the difference Δ measured using the respective surrogate metric may be relatively large and/or the associated variances (e.g., the variance σ_{C} of the responses A and the variance σ_{T} of the responses B) may be relatively small). The surrogate metric(s) identified by the sensitive surrogate metrics identification methods can be used in an experimentation platform to determine an output of a current controlled experiment. In an aspect, the sensitive surrogate metrics identification methods can use past experiment data of a plurality of metrics from previous controlled experiments (e.g., performed prior to the current controlled experiment). In an example, the past experiment data are available on the experimentation platform, and thus eliminating the need for data logging before each controlled experiment.

Examples of controlled experiments, an experimentation platform configured to conduct controlled experiments, and methods to analyze results of controlled experiments are described.

Controlled testing can include A/B testing, multivariate testing, and/or the like.

In A/B testing, two versions of a variable can be shown to two user groups, respectively. A/B testing can also be referred as an A/B experiment, a split test, or the like. A/B testing can include randomizing user traffic to multiple versions of a variable, computing a difference in one or more metrics, and running statistical tests to rule out differences due to noise.

In an example, the multiple versions of the variable include a control version of the variable and a treatment version of the variable. The treatment version can be modified from the control version, and thus can be a modified version of the control version. The user groups can include a user group A (Group A) and a user group B (Group B). In an example, the control version is only shown to users in the user group A, and the treatment version is only shown to users in the user group B. User responses including responses A from Group A and responses B from Group B can be obtained using the target metric. The responses A from the user group A can include responses of the user group A to the control version, and the responses B from the user group B can include responses of the user group B to the treatment version. The user responses can be analyzed, for example, using statistical analysis to determine if the responses A from the user group A and the responses B from the user group B are different (e.g., statistically different). In an example, the responses A and the responses B are statistically different and the responses B indicate more preferable responses than the responses A, and thus the treatment version can be selected. For example, the control version is replaced by the treatment version. In an example, A/B testing is applied iteratively to obtain a treatment version that can generate statistically more preferable responses B than the responses A.

The above description of A/B testing can be suitably adapted. In an example, more than two versions of a variable are applied to different user groups (e.g., two or more user groups). In an example, a variation to A/B testing is referred to as a multivariate testing. In multivariate testing, multiple variables can be varied. Different combinations of the multiple variables can be shown to different user groups to determine which combination of the multiple variables or which treatment variants are to be used based on a target metric.

When a controlled experiment is performed online, the controlled experiment may be referred to as an online controlled experiment.

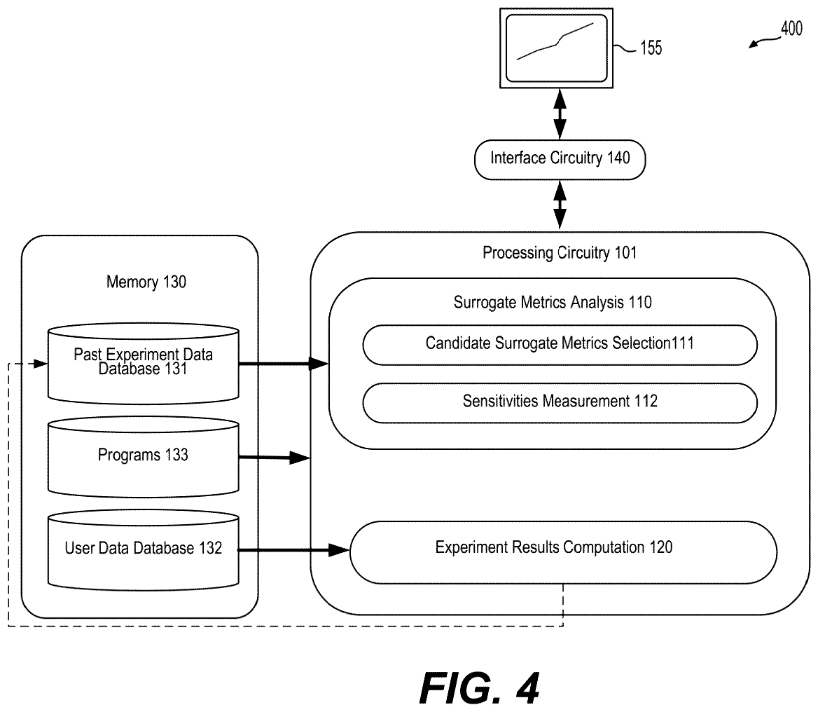

An experimentation platform can refer to a system designed for conducting controlled experiments. In an example, an experimentation platform refers to a software, a tool, or a system (e.g., a specialized software or system) configured to conduct controlled experiments (e.g., A/B experiments). The controlled experiments are used in various fields such as technology, product development, marketing, and user experience design to evaluate the impact of changes or strategies on specific metrics or outcomes. The term “experimentation platform” may include various software tools, frameworks, or systems that can facilitate the setup, execution, and analysis of the controlled experiments. The experimentation platform can provide an infrastructure for designing experiments, segmenting users, collecting data, and performing statistical analyses to determine the effectiveness of different strategies or product variations. An experimentation platform can be implemented as computer software using computer-readable instructions and stored in one or more computer-readable media. In an example, an experimentation platform is performed by processing circuitry such as processing circuitry (101) in FIG. 4.

A scenario (also referred to as a test scenario) in a controlled experiment, such as A/B testing, can include a description of a specific situation or use case where (i) multiple versions of a variable or (ii) combinations of multiple variables are compared. For example, how different headlines, images, or colors affect a conversion rate of a landing page can be compared. In this example, the metric used is the conversion rate. Variables or features can include headlines, images, or colors of a web page, a computer application, or the like. For example, different colors represent different versions (or different variants) of the variable “color”. A test scenario can describe inputs, actions, and expected outcomes for each version of the variable being tested. By creating test scenarios, how an application (e.g., a computer application such as a computer game, a specific software, or the like) or website (e.g., a web page) performs under different conditions (e.g., different colors or different font sizes of certain elements in a web page) can be evaluated and a solution can be determined for the goal (e.g., described by a metric such as a retention rate).

In an example, in a test scenario, a click-through rate of two different call-to-action buttons on a webpage can be compared. Inputs can include the button text, color, and position. The actions include clicking on the button or not. The expected outcome includes the percentage of visitors who click on the button. In this example, the feature includes the button text, color, or position of the call-to-action button, and different variables include different button texts, different colors, or different positions. The user responses include clicking on the button or not.

A test scenario can describe (e.g., define) variable(s) (e.g., a variable such as headline, button, or form) to be tested; versions of the variable to be compare (e.g., a version A and a version B such as a color A and a color B); and a metric used to measure an object of the controlled experiment (e.g., a conversion rate, a bounce rate, a sign-up rate). The test scenario can also include additional information, such as a target audience to be tested (e.g., new visitors, returning visitors, mobile users), a duration and a sample size of the test (e.g., one week, 1000 visitors per version), and/or the like.

Metrics can include measurements (e.g., quantifiable measurements), key performance indicators (KPIs), and/or the like that are used to assess various aspects of objectives, for example, the objectives of a controlled experiment (e.g., A/B testing). In an example, metrics include measurements used to evaluate the performance of each version and determine a winner (e.g., among different versions) of A/B testing. Some examples of metrics in A/B testing include webpage metrics. Examples of webpage metrics include one or a combination of (i) a conversion rate that indicates a percentage of users who complete a desired action, such as signing up, buying something, or clicking a button; (ii) a bounce rate indicating a percentage of visitors who leave a website after viewing only one page; (iii) an average session duration indicating an average amount of time that visitors spend on a website during a single visit; (iv) an events per session: an average number of actions or interactions that visitors perform on a website during a single visit; and/or the like.

The choice of metrics can depend on the objective of the controlled experiment, the variables being tested, hypothesis of the A/B test, and/or the like. In a controlled experiment (e.g., A/B testing), user responses (e.g., the responses A and the responses B described above) can be measured according to respective metrics and are associated with the respective metrics. In an example, a target metric (e.g., the North Star metric or the true north metric) can represent an objective (or a goal) of a controlled experiment. The target metric can vary with objectives, variable(s) being tested, versions being used in scenarios, and/or the like, such as a retention rate, user engagement, or the like.

A model where there are two states of the truth can be used in a controlled experiment. A null hypothesis H₀ indicates that there is no treatment effect, and an alternative hypothesis H₁ indicates that there is non-zero treatment effect. A statistical hypothesis test can refer to a method of statistical inference used to decide whether data (e.g., the responses from A/B testing) sufficiently supports a particular hypothesis, such as the null hypothesis or the alternative hypothesis. The null hypothesis can refer to a default assumption that nothing changes or no treatment effect (e.g., no true effect, no true difference) in the controlled experiment, e.g., the treatment version makes no difference as compared to the control version. For the null hypothesis to be rejected, an observed result (e.g., a difference Δ between the treatment version and the control version) is to be statistically significant. Statistical significance can be used to determine whether the null hypothesis is to be rejected or retained.

A p-value can be used to test the statistical significance of a result (e.g., to determine whether the result is statistically significant). The p-value refers to the probability of obtaining a result at least as extreme as the observed result if the null hypothesis is true. A low p-value indicates that the result is unlikely to be due to chance alone, and therefore provides evidence against the null hypothesis.

The threshold for deciding whether a p-value is low enough to reject the null hypothesis is referred to as a significance level α, and can be pre-specified (e.g., 0.05 or 5%). The null hypothesis is rejected if the observed p-value is less than the pre-specified significance level α. In an example, α is 0.05, if the p-value is less than or equal to 0.05, the result is considered statistically significant, and the null hypothesis is rejected.

Statistical analysis can be applied to analyze data in a controlled experiment, for example, to determine if a difference Δ between two user groups (e.g., Group A and Group B) is statistically significant, e.g., if the responses A from Group A are statistically different from the responses B from Group B. Statistical significance can refer to a way to determine if the difference Δ between the two user groups is statistically significant, e.g., if the difference is likely because of a real change or due to a random chance. If the difference is statistically significant, there is strong evidence that the change (e.g., the different Δ) is not random, and the difference Δ is meaningful for making a decision with a high level of confidence that the difference is real.

In an example of an A/B experiment, two distributions X and Y are associated with Group A (the control group) and Group B (the treatment group), respectively. τ_{C} and τ_{T} are means (or averages) of the distributions X and Y, respectively. σ_{C} and σ_{T} are variances of the distributions X and Y, respectively. Variance (e.g., σ_{C}) can refer to an expectation of the squared deviation from the mean (e.g., τ_{C}) of a variable or a distribution (e.g., a random variable or a random distribution), such as Y. The true means τ_{T} and τ_{C} and the true variances σ_{C} and σ_{T} of the two distributions may not be known, however, the two distributions X and Y can be measured or observed. yi, i=1, . . . , N_{T} can represent the observations for the treatment group Y, and xi, i=1, . . . , N_{C} can represent the observations for the control group X. N_{T} and N_{C} represent sample sizes for the treatment group and the control group, respectively, in the A/B experiment. The true means τ_{T} and τ_{C} and true variances σ_{C} and σ_{T} of the two distributions can be estimated using the observations yi and xi, for example, when the sample sizes N_{T} and N_{C} are large (e.g., larger than a size threshold). Δ can represent the observed difference (e.g., a metric difference measured based on a specific metric) between treatment and control. Δ can be equal to X̅− Y̅ where X̅ represents the mean of the observations xi and Y̅ represents the mean (or average) of the observations yi. The measurements or experiment data yi, i=1, . . . , N_{T} and xi, i=1, . . . , N_{C} can vary with the metrics, and X, Y, and A can also vary with the metrics.

The null hypothesis H₀: τ_{T}−τ_{C}=0 (there is no treatment effect) can be tested against the alternative hypothesis H₁: τ_{T}≠τ_{C} (there is non-zero treatment effect). How accurately the null hypothesis H₀ can be tested against the alternative hypothesis H₁ can depend on the size of the difference Δ between two user groups (e.g., Group A and Group B), the variances estimated from the observations xi and yi, and the like. In an example, if the difference Δ is relatively small and/or the variances of xi and yi are relatively large, then whether the null hypothesis H₀ is true may be difficult to determine, as described below.

When the difference Δ is relatively small, whether the null hypothesis H₀ is true is more difficult to determine if the variances of xi and yi are relatively large. On the other hand, when the difference Δ is relatively small, whether the null hypothesis H₀ is true is easier to determine if the variances of xi and yi are relatively small. In some examples, sizes of the variances of xi and yi decrease with sample sizes (e.g., N_{C} and N_{T}).

In some examples, the primary objective in controlled experiments (e.g., A/B experiments) is to achieve a significant enhancement in target metrics (e.g., the “North Star” metrics), such as user retention and active user counts. However, detecting substantial alterations in the target metrics may be challenging for the following reasons: (1) North Star metrics may result in (e.g., exhibit) changes that are small (e.g., A in A/B testing is small) and thus may be challenging to discern whether the change A is statistically significant, for example, due to limitations in sample sizes. For example, a small sample size may increase the variances. Thus, small changes (e.g., slight changes) exhibited by the North Star metrics are more difficult to observe than larger changes when the sample size is small. For example, when a sample size (e.g., a number of users participating in the controlled experiment) is small, a relatively small change (e.g., a difference Δ) in a North Star metric may be determined as not being statistically significant even though the small change A is due to the treatment. (2) Experiment durations may not be adequate (e.g., may not be long enough) to capture variations in long-term metrics (e.g., long-term North star metrics), such as 14-day retention or 30-day retention.

In an example, the collective impact of multiple strategies may lead to noteworthy improvements (e.g., statistically significant changes), when individual experiments do not display statistical significance.

In addition to variance, a pre-exposure bias can make it difficult to test the null hypothesis and the alternative hypothesis. In an example, in perfectly balanced groups, a difference Δ between the responses from Group A and Group B is zero if the control version and the treatment version are identical. Thus, in perfectly balanced groups, a difference Δ between the responses from Group A and Group B may be only due to the effect of the treatment. However, randomization may not result in perfectly balanced groups. A pre-exposure bias can be used to indicate such an imbalance between the groups. A pre-exposure bias can indicate a statistically significant difference between Group A and Group B with the same value (e.g., the control version and the treatment version are identical) for the variable, e.g., before A/B testing. In an example, a statistically significant difference between Group A and Group B before an experiment starts is referred to as a pre-exposure bias.

Techniques may be employed to overcome challenges such as relatively large variances in X and Y and the pre-exposure bias. For example, a controlled-experiment using pre-experiment data (CUPED)) can be designed to enhance the speed and accuracy of experiments on an experimentation platform by harnessing pre-experimental data to mitigate variance (e.g., to reduce variances of X and Y) and to reduce pre-exposure bias in experiment outcomes, resulting in the generation of narrower confidence intervals and lower p-values. A confidence interval (CI) can be a range of estimates for an unknown parameter, such as X or Y. The above approach can be advantageous in expediting the delivery of experiment results and mitigating the influence of pre-exposure bias.

The pre-experimental data can refer to data (e.g., user behavior data indicating various user behaviors) collected from users before the users participate in the controlled experiment. For example, the pre-experimental data (e.g., various behavior data of the users) are collected when the users are not participating in controlled experiments. Thus, in an example, at least a subset of the pre-experimental data does not include data (e.g., the responses A and the responses B) collected during controlled experiments.

Mitigation techniques (e.g., CUPED) may be limited when dealing with certain test scenarios. In some examples, techniques such as CUPED may be less effective for handling new users as pre-experiment data for new users may not be available or relatively scarce. Further, variance of metrics that lack correlation with historical behavior (e.g., indicated by the user behavior data) of users may be difficult to reduce.

An aspect of the disclosure includes solutions that address the above challenges more effectively. The disclosure includes the methods (or the approaches) (e.g., the sensitive surrogate metrics identification methods) that can identify sensitive surrogate metrics within an experimentation platform that is configured to perform controlled experiments (e.g., A/B testing). The method can (i) determine (e.g., uncover) correlations between a target metric (e.g., a north star metric) and surrogate metrics that are indicative of the target metric and (ii) measure sensitivity of a surrogate metric (e.g., how sensitive the surrogate metric is in terms of having a statistically significant change) by utilizing advanced data analysis techniques. Thus, the sensitive surrogate metrics identification methods can enable the selection of effective sensitive surrogate metrics for accurate performance assessment. The methods of sensitive surrogate metrics identification and application can significantly improve functions (including improvement in website and computer application design) of a computer that implements the methods. The methods can yield a significant technical advancement by enhancing the precision of metric evaluation (e.g., selecting the sensitive surrogate metrics that are good indicators of the target metric and have high sensitivity to treatment effect) in experimentation platforms, providing greater clarity in experimental results to facilitate informed product decision-making, leading to improved decision-making (e.g., determining an output) in A/B experiments. The computer that implements the methods can increase the accuracy of the determination of the output of a controlled experiment since the determination is based on the selected surrogate metrics that can indicate the effect of the treatment more accurately. The computer can increase the efficiency or the speed of the design due to the usage of the past experiment data stored in the memory. Consequently, the methods address the challenge of selecting appropriate metrics (e.g., sensitive metrics that are correlated to the target metric) in experimental set ups, offering a valuable solution that elevates the reliability and efficiency of A/B experiment processes.

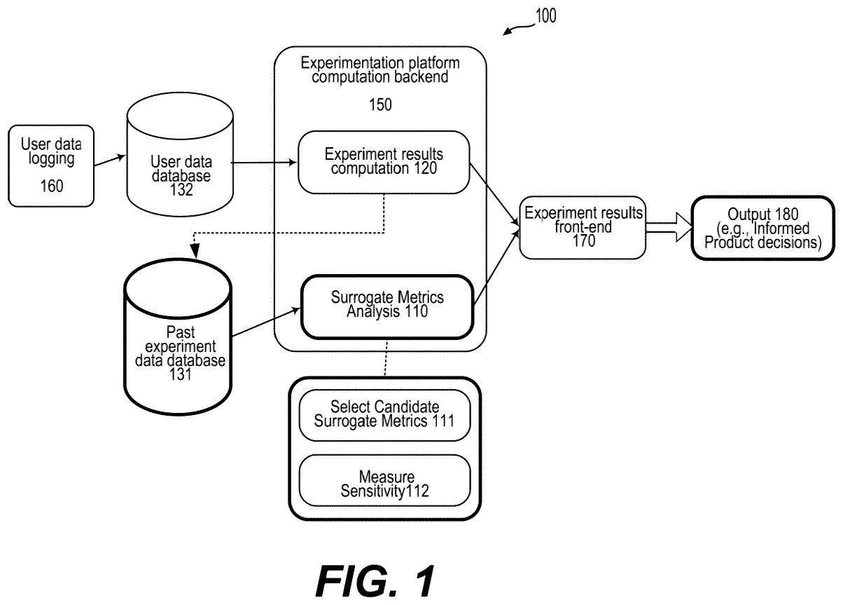

In an aspect of the disclosure, the methods can use past experiment data (or pre-existing past experiment data). The past experiment data can include past results (also referred to as first testing data) from previous controlled experiments. The past experiment data can be stored a database (e.g., (131) in FIG. 1 or 4) in memory. The previous controlled experiments (e.g., N previous controlled experiments) have been performed on different test variants of at least one variable to obtain the first testing data that are measured using a plurality of metrics. The previous controlled experiments can be performed on previous users (or first users). The plurality of metrics can include a target metric (e.g., the North Star metric) and a plurality of surrogate metrics that are indicative of the target metric.

In an example, the different test variants include a control variant and a treatment variant of a variable under test. The first testing data associated with each of the plurality of metrics can include multiple sets of responses that are associated with the respective previous controlled experiments (e.g., a first set of responses X₁ and Y₁ obtained from first A/B testing, a second set of responses X₂ and Y₂ obtained from second A/B testing, . . . , and an Nth set of responses X_{N} and Y_{N} obtained from Nth A/B testing). In an aspect of the disclosure, the past experiment data can be used to determine (e.g., select) at least one candidate surrogate metric from the plurality of surrogate metrics. The selected at least one candidate surrogate metric can be highly correlated with the target metric and thus can be good indicator(s) of the target metric. Further, the selected at least one candidate surrogate metric is highly sensitive to the treatment. The selected at least one candidate surrogate metric can be used in a current controlled experiment to determine an output of the current controlled experiment applied to current users (or second users).

The past experiment data used to determine the at least one candidate surrogate metric from the plurality of surrogate metrics and the pre-experiment data described above (e.g., used in CUPED) can be measured prior to the current controlled experiment. However, the past experiment data used to determine the at least one candidate surrogate metric from the plurality of surrogate metrics are different from the pre-experiment data described above (e.g., used in CUPED). For example, the past experiment data can be obtained (e.g., measured or collected) in the previously performed controlled experiments, and thus can include responses of previous users (or first users) to different versions of the at least one variable. The pre-experimental data is not collected in the previously performed controlled experiments. For example, the pre-experimental data (e.g., various behavior data of the users) are collected when the current users (or the second users) are not participating in controlled experiments.

Users participating in the previous controlled experiments to collect the past experiment data and the pre-experimental data collection can be different. The previous controlled experiments can be performed on the previous users (or the first users). The pre-experimental data are collected from the current users (or the second users). The current users participate in the current controlled experiment. The first users can be different from the second users, for example, the second users can include “new users” that are not included in the first users.

The availability of the past experiment data and the pre-experimental data to the experimentation platform can be different. In an example, the same experimentation platform may be used to perform the previous controlled experiments and the current controlled experiment, and the past experiment data is available to the experimentation platform. In an example, the pre-experimental data may be collected using other platforms that are different from the experimentation platform that performs the current controlled experiment, and data logging may be used to obtain the pre-experimental data. Thus, in some examples, using the past experiment data is more efficient than using the pre-experimental data.

The methods described in the disclosure can be applied to previous users and new users since the surrogate metrics identification methods use the past experiment data that are already available. Further, the amount of data in the past experiment data can include data from multiple previous controlled experiments, and thus the surrogate metrics identified can be indicators that are sensitive and correlate well with the target metric.

In an aspect of the disclosure, the methods determine correlations of the plurality of surrogate metrics with the target metric, and thus can identify metrics (e.g., surrogate metrics) that are closely linked (or correlated) to the target metric (e.g., the North Star metric), which is the metric of primary concern in a controlled experiment. The methods can also determine sensitivities of the metrics, and the metrics identified can also have high sensitivities and can be more likely to be influenced by the experimental variant, thus providing a clearer direction for decision-making. In some examples, techniques such as CUPED may not reveal the intricate relationships among the metrics and may not offer definitive guidance when less critical metrics (e.g., metrics with relatively low correlations with the North Star metric) display significant changes (e.g., high sensitivities).

The methods described in the disclosure addresses limitations associated with controlled experiments (i) performed on new users where the pre-experimental data is not available or is scarce; and/or (ii) controlled experiments using metrics (e.g., surrogate metrics) whose correlations with the target metric is relatively low (e.g., the surrogate metrics may be poor indicators of the target metric). The disclosure provides a more comprehensive solution for enhancing the clarity and effectiveness of experiment results in controlled experiments, ultimately aiding in informed product optimization decisions.

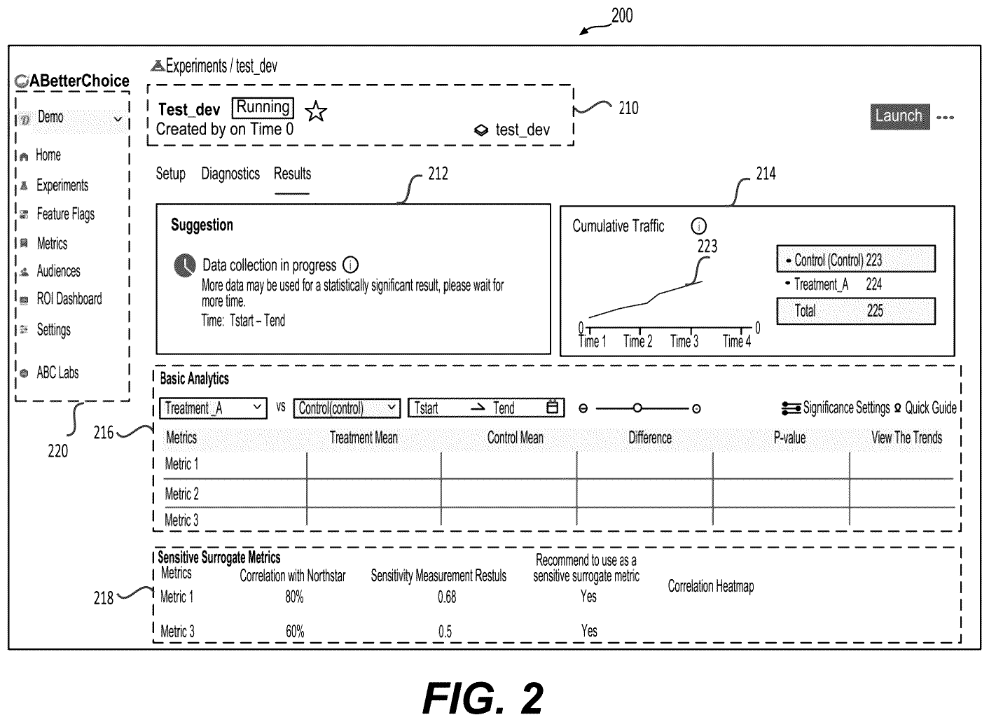

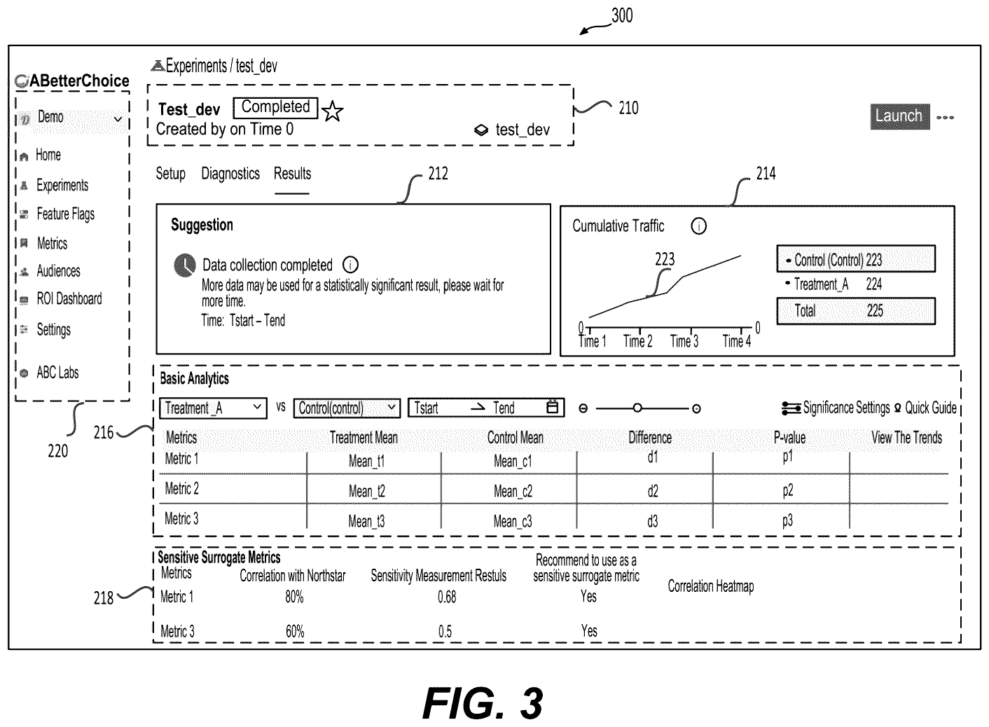

The methods can be implemented on any suitable experimentation platforms to help experimenters (e.g., users of the experimentation platforms) better understand the experiment results and make product decisions. In an example, the methods are implemented as an add-on function (or an add-on functionality) on any suitable experimentation platform. FIG. 1 shows an example of a flowchart (100) including computations (e.g., back-end computations) according to an aspect of the disclosure. FIGS. 2-3 show examples of frontend screenshots (200) and (300) according to an aspect of the disclosure. FIG. 4 shows an example of a system (400) configured to perform the methods according to an aspect of the disclosure.

Referring to FIG. 1, the flowchart (100) describes an example of implementing the surrogate metrics analysis (also referred to as the sensitive surrogate metrics analysis) (110) in a computation backend (150) of an experimentation platform. The computation backend (150) can include steps (110) and (120). The step (110) includes the surrogate metrics analysis. The step (120) includes experimental results computation of a current controlled experiment.

The disclosure describes the methods of identifying sensitive surrogate metrics within experimentation, a process that depends on metrics highly correlated with the primary “North Star” metric and their propensity to exhibit significant changes under specific strategic scenarios. This process comprises two key steps (111) and (112) described below.

Past experiment data (or first testing data) collected from past users (or first users) in previous controlled testing (e.g., the N past controlled experiments that were previously performed prior to the current controlled experiment) can be stored in a database (e.g., a past experiment data database) (131). The database (131) can be stored in memory (e.g., (130)). The surrogate metrics analysis step (110) can utilize the past experiment data from the past experiment data database (131). The surrogate metrics analysis step (110) can include two computations, e.g., selecting candidate surrogate metrics (in a step (111)) from the plurality of surrogate metrics and measuring sensitivities of the selected candidate surrogate metrics (in a step (112)). In the step (111), correlations between each of the plurality of surrogate metrics and the target metric can be determined based on the past experiment data. The candidate surrogate metrics can be determined (e.g., selected) from the plurality of surrogate metrics based on the determined correlations. In the step (112), a plurality of sensitivities of the respective candidate surrogate metrics can be determined based on the past experiment data. A sensitivity of one of the candidate surrogate metrics can indicate a probability that a change of a variable from the control variant to the treatment variant induces an effect that is detected as a statistically significant change in the one of the candidate surrogate metrics. Further, in the step (110), at least one candidate surrogate metric can be selected from the candidate surrogate metrics based on the determined plurality of sensitivities.

User data (or current user data) of current users (or second users) can be collected, for example, via user data logging (160). As described above, the second users can be different from the first users. In an example, a subset of the first users is different from a subset of the second users.

The user data can include second testing data associated with the plurality of metrics. The user data can be stored in a user data database (132). Current controlled testing can be performed on the user data stored in the user data database (132) using an experimental results computation step (120). In the step (120), current testing results that are associated with the plurality of surrogate metrics can be determined. In an example, the current testing results can be sent to the past experiment data database (131) and added to the past experiment data for use in future surrogate metrics analysis.

The steps (110) and (120) can be implemented in any suitable order. In an example, the steps (110) and (120) are implemented in parallel. In an example, one of the steps (110) and (120) is implemented prior to the other of the steps (110) and (120).

During operation, when a user (e.g., an experimenter) of the experiment platform reads the experiment results in a frontend (such as shown in FIGS. 2-3) of the experimentation platform, the user can be informed with a) regular experiment results (or current experiment results) and b) surrogate metrics analysis results (or sensitive surrogate metrics analysis results). The current experiment results can be obtained by the step (120). The current experiment results can include metric comparisons showing mean values (e.g., X̅ or Y̅) of the metrics (e.g., the plurality of metrics including the plurality of surrogate metrics and the target metric) and whether there are significant changes observed, for example, if Δ(X̅−Y̅) of a specific metric is statistically significant.

The surrogate metrics analysis results can be obtained by the step (110). The surrogate metrics analysis results can indicate the metrics (e.g., surrogate metrics) that are sensitive and highly correlated to the target metric (e.g., the North Star metric). For example, the surrogate metrics analysis results indicate the at least one candidate surrogate metric that is selected from the candidate surrogate metrics.

The current experiment results and/or the surrogate metrics analysis results can be displayed, for example, at a front-end as the experimental results at the front-end (170), such as shown in FIGS. 2-3.

An output (180) of the current controlled testing can be determined based on one or more of the current testing results associated with the at least one candidate surrogate metric. In an example, the output of the current controlled testing of the control variant and the treatment variant indicates whether the treatment variant replaces the control variant of the feature of the webpage or the computer application. If the output indicates that the treatment variant replaces the control variant of the feature of the webpage or the computer application, the control variant of the feature is replaced with the control variant. With the additional information on the surrogate metrics, the experimenter can make informed and fast product decisions even without seeing significant changes in the North Star metric. The decisions can be “informed” because (i) the surrogate metrics used to inform the decision are good indicators of the target metric (e.g., the correlations between the surrogate metrics and the target metric are above the correlation threshold) and (ii) the surrogate metrics are sensitive such that changes measured by the surrogate metrics are relatively large compared with the corresponding variances. The decisions can be “fast” because the surrogate metrics are determined from a plurality of surrogate metrics (e.g., pre-defined) using the past experiment data without the need of user data logging for the determination of the surrogate metrics. The computer implementing the methods described in FIG. 1 can increase the accuracy of the determination of the output of a controlled experiment since the determination is based on the selected surrogate metrics that can indicate the effect of the treatment more accurately. The computer can increase the efficiency or the speed of the design due to the usage of the past experiment data stored in the memory. The methods described in FIG. 1 (e.g., implemented by the computer) can be applicable to new users while some related technologies may not be applicable to the new users.

FIGS. 2-3 show examples of the front-end display (e.g., a screenshot) (200) and (300) taken at two different times according to an aspect of the disclosure. The displays (200) and (300) can include any suitable information of the current controlled testing and can be arranged in any suitable way. Different types of information can be arranged in respective sections of the front-end display (200) or (300), and thus the same label can be used to refer to the type of information and the corresponding section of the front-end display (200) or (300). In an example, result information (216) indicating the current experiment results is located in a corresponding current experiment results section, and thus the result information and the corresponding current experiment results section are labeled with (216). Similarly, metric information (218) indicating the surrogate metrics analysis results is located in a corresponding sensitive surrogate metrics section, and thus the metric information and the corresponding sensitive surrogate metrics section are labeled with (218).

In an example, the displays (200) and (300) include testing status information (210), data collection status information (212), user information (214), result information (216) indicating the current experiment results, metric information (218) indicating the surrogate metrics analysis results, and a menu (220). One or more pieces of information to be displayed can be modified, combined, or omitted from the displays (200) and/or (300).

The testing status information (210) can include a test name (e.g., Test dev) of the current controlled testing, a creation time (e.g., Time 0) of the current controlled testing, and a testing status indicator (e.g., “Running” indicating that the current controlled testing is being performed).

The data collection status information (212) can indicate whether the data collection is completed. In the example in FIG. 2, the data collection is in progress, for example, more data is collected for the current controlled testing. In the example in FIG. 3, the data collection is completed, for example, no more data is collected for the current controlled testing.

The user information (214) can include information of different groups of users, such as Group A and Group B. In the example of FIG. 2, the user information (214) includes a cumulative traffic of Group A (223), a cumulative traffic of Group B (224), and a total cumulative traffic (225) that is a sum of the cumulative traffic of Group A (223) and the cumulative traffic of Group B (224). The cumulative traffic of Group B (224) can be similar to the cumulative traffic of Group A (223), and thus for purposes of clarity, only the cumulative traffic of Group A (223) is shown in FIG. 2. Cumulative traffic can correspond to, or indicate, cumulative exposure, for example.

The result information (216) can indicate the current experiment results. For each metric (e.g., a metric 1, a metric 2, and the like) used in the current controlled testing, the result information (216) can include a treatment mean (e.g., Y) that is a mean value of the responses B of Group B measured by the metric, a control mean (e.g., X) that is a mean value of the responses A of Group A measured by the metric, a difference Δ (such as a relative difference) between the treatment mean and the control mean, statistical information indicating whether the difference Δ between the treatment mean and the control mean is statistically significant, and the like. In an example, the statistical information includes a p-value.

The metric information (218) can indicate the surrogate metrics analysis results. In an example, information associated with the at least one surrogate metric identified by the step (110) is displayed, including a correlation between the respective surrogate metric and the target metric, a sensitivity of the respective surrogate metric, and an indication whether the respective surrogate metric is recommended to be used as a sensitive surrogate metric. The information associated with the at least one surrogate metric may also include a correlation heatmap. A correlation heatmap can refer to a graphical tool that displays a correlation between multiple variables as a color-coded matrix. Referring to FIG. 2, the at least one surrogate metric includes the metric 1 and the metric 3 that are recommended to be used as sensitive surrogate metrics. The correlation between the metric 1 and the target metric 80% and the sensitivity of the metric 1 is 0.68. The correlation between the metric 2 and the target metric 60% and the sensitivity of the metric 2 is 0.5. The metric information (218) can also include metric information of metrics that are different from the at least one surrogate metric identified by the step (110).

The menu (220) can include various actions that can be used to navigate in the experimental platform.

When a user using the experimentation platform logs onto the experimentation platform and clicks on the Results page, the user can see both the current experiment results section (and thus can see the result information) (216) and the sensitive surrogate metrics section (and thus can see the metric information) (218). The sensitive surrogate metrics section (218) can indicate information on detailed sensitive surrogate metrics analysis results and whether metric(s) are recommended as sensitive surrogate metric(s) by the experimentation platform.

In FIG. 2, the current controlled testing is in a “Running” status, and thus is not completed. Accordingly, the result information (216) is incomplete.

In FIG. 3, the current controlled testing is in a “Completed” status as indicated by the testing status information (210), and thus is completed. Accordingly, the result information (216) is completed. In the example shown in FIG. 3, the current experiment results include treatment means (e.g., Mean_t1, Mean_t2, Mean_t3, . . . ) of the metrics tested (e.g., the metrics 1, 2, 3, . . . ), control means (e.g., Mean_c1, Mean_c2, Mean_c3, . . . ) of the metrics tested, differences (e.g., d1, d2, d3, . . . ) of the metrics tested, and p-values (e.g., p1, p2, p3, . . . ) of the metrics tested. The user information (214) in FIG. 3 shows additional traffic when compared with the user information (214) in FIG. 2.

In an example, the surrogate metrics analysis results in the metric information (218) are obtained prior to the completion of the current controlled testing, and thus the completed surrogate metrics analysis results are shown in FIGS. 2-3. In some examples, the surrogate metrics analysis results in the metric information (218) are obtained after the completion of the current controlled testing, and thus the surrogate metrics analysis results may not be shown when the current controlled testing is in the “Running” status (in FIG. 2).

Referring to FIG. 3, the at least one candidate surrogate metric selected (indicated by the metric information (218)) includes the metrics 1 and 3. Thus, the metrics 1 and 3 are better indicators of the target metric and are more sensitive (e.g., a larger difference and/or less variances) to treatment effect than other metrics used in the current controlled testing. Accordingly, the results from the metrics 1 and 3 (e.g., shown in the result information (216)) can be used to determine the output of the current controlled testing, and thus the output can be determined more accurately and faster. The output can indicate whether the treatment variant or the control variant is to be used in the feature of the webpage or the computer application. If the output indicates that the treatment variant is used, then the treatment variant replaces the control variant of the feature. Since the metrics 1 and 3 are better indicators of the target metric and are more sensitive, a smaller sample size may be used to achieve an accurate determination of the output, and thus the determination can be faster. In an example, the results from the metrics 1 and 3 show statistically significant differences d1 and d3, and thus the output can include replace the control version with the treatment version in the feature of the webpage or the computer application. In an example, the result from the metric 2 shows the statistically significant difference d2, however, the results from the metrics 1 and 3 do not show statistically significant differences d1 and d3, and thus the output can include do not replace the control version with the treatment version in the feature of the webpage or the computer application.

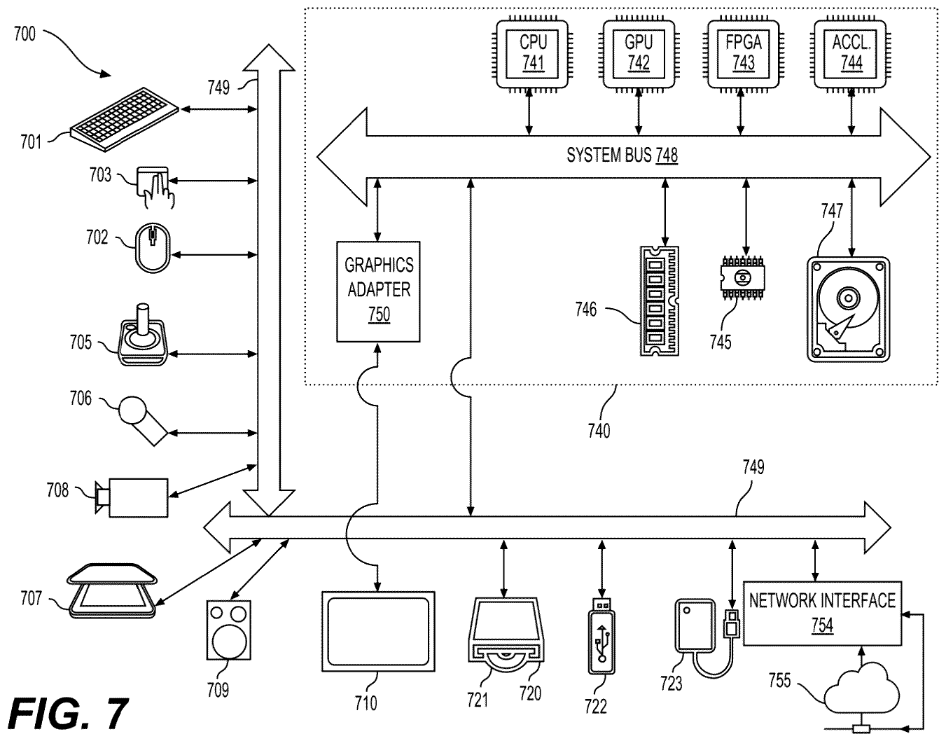

Referring to FIG. 4, the system (400) can be configured to perform the methods, including aspects, examples, and steps described in FIGS. 1-3. The system (400) can include processing circuitry (101), memory (130), and interface circuitry (140). The memory (130) can be configured to store various programs, instructions, and data. The data stored in the memory (130) can include the past experiment data (or the first testing data) and the user data (or the current user data). In an example, the memory (130) includes databases, such as the past experiment data database (131) that stores the past experiment data and the user data database 132 that stores the user data, such as described in FIG. 1. The memory (130) can store programs or instructions (133) which when executed by the processing circuitry (101) can cause the processing circuitry (101) to perform the methods described in the disclosure. The memory (130) can include any suitable memory or storage device such as described in FIG. 7.

The processing circuitry (101) can be configured to perform any suitable computations including the backend computations (150) described in FIG. 1. For example, the processing circuitry (101) is configured to perform the surrogate metrics analysis (110) and the experimental results computation (120), such as described in FIG. 1. The surrogate metrics analysis (110) can include the step of candidate surrogate metrics selection (or selecting candidate surrogate metrics) (111) and the step of sensitivities measurement (112).

The step of candidate surrogate metrics selection (111) can include determining correlations between each of the plurality of surrogate metrics and the target metric based on the first testing data. Any suitable method, such as machine learning (ML) models and correlation analyses, can be used to determine a correlation between one of the plurality of surrogate metrics and the target metric, which is a statistical measure that indicates how the one of the plurality of surrogate metrics and the target metric are related to each other. The more the one of the plurality of surrogate metrics is correlated with the target metric, the better the one of the plurality of surrogate metrics is indicative of the target metric.

In an example, the correlation between the one of the plurality of surrogate metrics and the target metric is calculated based on a subset of the past experiment data associated with the one of the plurality of surrogate metrics and the target metric, such as the responses of the first users to different variants that are measured with the one of the plurality of surrogate metrics and the target metric, respectively. In an example, a correlation coefficient such as a Pearson's correlation coefficient is directly calculated based on the subset of the past experiment data associated with the one of the plurality of surrogate metrics and the target metric. In an example, the correlation coefficient r is calculated directly using Eq. (1) below. xᵢ and x̅ represent sample values and a mean of the subset of the past experiment data associated with the target metric, respectively. yᵢ and y̅ represent sample values and a mean of the subset of the past experiment data associated with the one of the plurality of surrogate metrics, respectively.

$$r = \frac{Σ ( {x}_{i} - \overline{x} ) ( {y}_{i} - \overline{y} )}{\sqrt{Σ {( {x}_{i} - \overline{x} )}^{2}} {( {y}_{i} - \overline{y} )}^{2}} \qquad Eq . ( l )$$

In an example, the subset of the past experiment data associated with the one of the plurality of surrogate metrics and the target metric can be input into an ML model. An output including a correlation (e.g., a correlation coefficient) between the one of the plurality of surrogate metrics and the target metric can be obtained (or received) from the ML model. In an example, a correlation heatmap can be used to select the candidate surrogate metrics.

In an aspect, candidate surrogate metrics can be determined (e.g., selected) from the plurality of surrogate metrics based on the determined correlations (e.g., the correlation coefficients) between the candidate surrogate metrics and the target metric. The correlations between the candidate surrogate metrics and the target metric can satisfy a condition, e.g., the correlation coefficients between the candidate surrogate metrics and the target metric are larger than a correlation threshold. The correlation threshold can be pre-defined, such as 0.5 (or 50%), 0.6 (or 60%).

Evaluating a sensitivity of a metric, such as a sensitivity of one of the candidate surrogate metrics can include assessing a likelihood of the one of the candidate surrogate metrics to undergo a substantial alteration compared to the target metric (e.g., the North Star metric) within specific strategic contexts.

The sensitivity of the metric can be based on two elements (or two components): a statistical power and a movement probability. For example, the sensitivity of the metric includes a statistical power and a movement probability. The statistical power can indicate a conditional probability of detecting the statistically significant change in the metric (e.g., the one of the candidate surrogate metrics) that is conditioned on the alternative hypothesis H₁ being true. The alternative hypothesis H₁ being true can indicate that the change of the variable from the control variant to the treatment variant induces the effect. The movement probability can be a probability of the alternative hypothesis H₁ being true.

In an example, the statistical power is used to denote the probability of detecting a statistically significant change when a true impact exists. The statistical power can be determined through hypothesis testing, where the null hypothesis H₀ assumes no real effect of the experimental strategy on the metric, and the alternative hypothesis H₁ assumes an actual effect. The statistical power can depend on various factors such as the mean value measured with the metric, a standard deviation, a sample size, and the like. In an example, the statistical power is expressed as:

$$P ( \vert Z \text{\textbar >} 1.96 \vert {H}_{1} ) \qquad Eq . ( 2 )$$

Z can be a test statistic (e.g., Z-statistics) constructed based on the mean value measured with the metric, the standard deviation, the sample size. A value 1.96 is a critical value for the test statistic to fall out of the 95% confidence interval in a standard normal distribution. The statistical power shown in Eq. (2) can be a conditional probability of |Z|>1.96 given that alternative hypothesis H₁ is true (e.g., there is an actual effect).

In an example, the test statistic (e.g., Z-statistics) is described as follows.

$$Z = \frac{\overline{X} - \overline{Y}}{\sqrt{{σ}_{T}^{2} {/}_{{N}_{T}} + {σ}_{C}^{2} {/}_{{N}_{C}}}} = \frac{Δ}{\sqrt{{σ}_{T}^{2} {/}_{{N}_{T}} + {σ}_{C}^{2} {/}_{{N}_{C}}}} \qquad Eq . ( 3 )$$

σ_{C} and σ_{T} are variances of X (e.g., the past experiment data associated with the control version and the metric) and Y (e.g., the past experiment data associated with the treatment version and the metric) and Δ is the observed metric difference between treatment and control. The variances σ_{C} and σ_{T} are unknown. When the sample size is large, the variances σ_{C} and σ_{T} can be approximated by the respective estimates. An effective sample size N_{E} is defined as N_{E}=1/(1/N_{T}+1/N_{C}). Let σ² be the pooled variance such that σ²=σ_{T}²/N_{T}+σ_{C}²/N_{C}. An effect size δ can be defined as δ=Δ/σ. Z-statistics can be rewritten as below:

$$Z = \frac{δ}{\sqrt{1 / {N}_{E}}} \qquad Eq . ( 4 )$$

The effect size δ can be the observed difference Δ scaled by the pooled standard deviation σ. In an example, σ is treated as a fixed constant. μ can represent an average treatment effect scaled by σ.

$$μ = E ( δ ) = E ( Δ ) / σ = ( {τ}_{T} - {τ}_{C} ) / σ \qquad Eq . ( 5 )$$

When σ is treated as known, inference on τ_{T}−τ_{C} and μ can be equivalent and μ can be the treatment effect. In an example, when there is no treatment effect, μ=0 (e.g., the null hypothesis H₀). The alternative hypothesis H₁ is the state where there is non-zero treatment effect μ.

The movement probability can represent the probability of an experimental strategy genuinely influencing a metric, which can be represented using P(H₁). The sensitivity of the metric can be determined by combining the statistical power and the movement probability, and the sensitivity of the metric can indicate the likelihood of detecting the statistically significant change when the experimental strategy truly impacts the metric. In an example, the sensitivity of the metric is a multiplication of the statistical power and the movement probability, e.g., P(|Z|>1.96|H₁)×P(H₁).

In an example, the selection of candidate surrogate metrics that does not rely on predictive models but employs independent and pre-existing metrics (e.g., including the plurality of surrogate metrics) is prioritized, such as described in FIGS. 1 and 4. Further, assessing sensitivity (e.g., using the step (112)) is important since a highly correlated surrogate metric may not exhibit a high sensitivity to the impact of an experimental strategy, and thus may not be useful in a controlled experiment. Thus, the determination of the correlation (e.g., using the step (111)) and the sensitivity (e.g., using the step (112)) of a surrogate metric is important.

As described in the disclosure, the output of the current controlled testing can be determined based on one or more of the current testing results associated with the at least one candidate surrogate metric. The output of the current controlled testing can indicate whether the treatment variant replaces the control variant of the feature of the webpage or the computer application. In response to the output indicating that the treatment variant replaces the control variant of the feature of the webpage or the computer application, the control variant of the feature can be replaced with the treatment variant of the feature of the webpage or the computer application.

In an example, the CUPED method increases the statistical power of a hypothesis test. Specifically, the CUPED method employs the pre-experiment data to reduce the standard deviation of a metric to achieve greater statistical power, e.g., increasing the probability of statistically significant changes when a true impact exists. However, as described above, in some examples, the CUPED method does not work on new users where the pre-experiment data does not exist. Further, in some examples, the CUPED method may be less informative to the experimenter when there is no or little information on how correlated the metrics are with the North Star metrics and how likely an experimental strategy genuinely influencing a metric.

Functions of a computer implementing the methods of the processing circuitry (101) can be significantly improved including improvement in website and computer application design. For example, the computer can increase the efficiency or the speed of the design due to the usage of the past experiment data. The computer can increase the accuracy of the determination of the output since the determination is based on the selected surrogate metrics that can indicate the effect of the treatment more accurately.

The step of sensitivities measurement (112) can include any suitable method(s) (e.g., a historical experiment data approach, a Bayesian approach, and/or the like) that determine (e.g., measure) the sensitivity of the metric. In an aspect, a historical experiment data approach is used to directly calculate the proportion of experiments in which significant metric changes occurred, accounting for the 5% error rate inherent in the hypothesis testing.

In another aspect, a Bayesian approach is used to determine the sensitivity of the metric. In the Bayesian approach, Bayesian techniques can be leveraged. In an example, results from the N past experiments (e.g., the N previous controlled experiments) are collected. Effect sizes of the metric using the historical experiment data can be standardized. An example of an effect size δ of the metric is described above. Latent variables (e.g., p and the standard deviation V) can be estimated and can be combined with the effect sizes and the effective sample size information, and thus offering a robust method for measuring the sensitivity. In an example, the effect sizes (denoted by δᵢ (i=1, . . . , N)) of the sensitivity can be measured after standardizing it across the experiments. The effective sample sizes of the experiments are N_{Ei} (i=1, . . . , N). An example of an effective sample size of the experiments is N_{E} (N_{E}=1/(1/N_{T}+1/N_{C})) described above. An average effect size μ=E(δ) can be statistically inferred. Under the null hypothesis, μ=0. Simultaneously, under the alternative hypothesis, μ˜N (0, V²) and P(H₁)=p. μ˜N (0, V²) can indicate a normal distribution where a random variable μ is normally distributed with a mean of 0 and a standard deviation V. An expectation-maximization (EM) algorithm can be used to assess (e.g., determine) the two latent variables, p and the standard deviation V, and thus deduce the sensitivity of the metric.

In an aspect, the at least one candidate surrogate metric is selected based on the sensitivities of the respective candidate surrogate metrics.

In an aspect, the at least one candidate surrogate metric is selected based on the sensitivities of the respective candidate surrogate metrics and a sensitivity threshold.

In an aspect, the sensitivities of the respective candidate surrogate metrics can be ranked and the at least one candidate surrogate metric is selected according to the ranked sensitivities.

In an aspect, the at least one candidate surrogate metric is selected from the plurality of surrogate metrics based on the correlations and the sensitivities of the respective surrogate metrics.

Information and/or results associated with the controlled testing and/or the past controlled testing can be communicated, via wired and/or wireless communications, between the processing circuitry (101) and human interface devices (e.g., a display device (155)) via the interface circuitry 140. Various information and/or results can be displayed, such as shown in FIGS. 2-3. In an example, the display device (155) can display the at least one candidate surrogate metric in a graphical user interface (GUI). In an example, the display device (155) can display the output of the current controlled testing in the GUI.

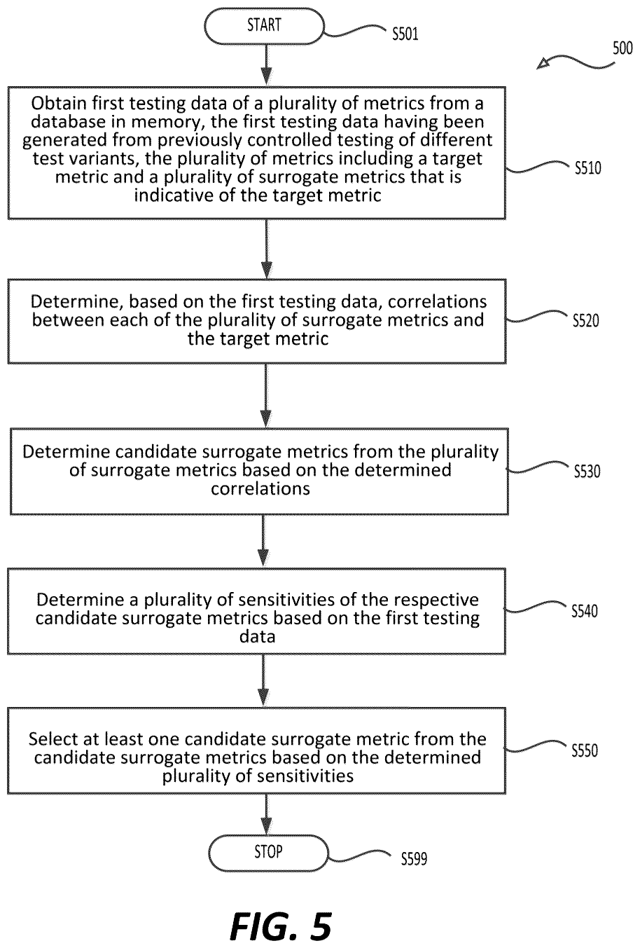

FIG. 5 shows a flow chart outlining a method (500) according to an aspect of the disclosure. The method (500) can be used in an experimental platform. In various aspects, the method (500) is executed by processing circuitry, such as the processing circuitry (101) that performs functions of the experimental platform. In an aspect, the method (500) is implemented in software instructions, thus when the processing circuitry executes the software instructions, the processing circuitry performs the method (500). The process starts at (S501) and proceeds to (S510).

At (S510), first testing data (e.g., the past experiment data in the database 131 described in FIGS. 1 and 4) of a plurality of metrics can be obtained from previously controlled testing of different test variants (or different test versions) of a feature (or a variable) of a webpage or a computer application. The plurality of metrics can include a target metric (e.g., a North Star metric) and a plurality of surrogate metrics that is indicative of the target metric. The different test variants can include a control variant and at least one treatment variant of the feature of the webpage or the computer application. In an example, the at least one treatment variant is a treatment variant. In an example, the first testing data is stored in memory (e.g., the memory (130)).

In an example, the previously controlled testing of the different test variants includes A/B testing of the control variant and the treatment variant of the variable.

At (S520), correlations (e.g., correlation coefficients) between each of the plurality of surrogate metrics and the target metric can be determined based on the first testing data, such as in the step 111 described in FIGS. 1 and 4.

In an example, a subset of the first testing data that is associated with one of the plurality of surrogate metrics and the target metric is input into a machine learning (ML) model. An output indicating a correlation (e.g., a correlation coefficient) between the one of the plurality of surrogate metrics and the target metric can be received from the ML model.

At (S530), candidate surrogate metrics from the plurality of surrogate metrics can be determined based on the determined correlations, such as in the step 111 described in FIGS. 1 and 4. In an example, the correlations between the determined candidate surrogate metrics and the target metric satisfy a condition, such as the correlation coefficients are larger than a correlation threshold.

At (S540), a plurality of sensitivities of the respective candidate surrogate metrics can be determined based on the first testing data, such as in the step 112 described in FIGS. 1 and 4. A sensitivity of one of the candidate surrogate metrics can indicate a probability that a change of the feature of the webpage or the computer application from the control variant to the treatment variant induces an effect that is detected as a statistically significant change in the one of the candidate surrogate metrics.

In an example, the sensitivity of the one of the candidate surrogate metrics includes two elements: (i) a statistical power that indicates a conditional probability of detecting the statistically significant change in the one of the candidate surrogate metrics that is conditioned on an alternative hypothesis H₁ being true and (ii) a probability of the alternative hypothesis being true, such as in the step 112 described in FIGS. 1 and 4. The alternative hypothesis being true can indicate that the change of the variable from the control variant to the treatment variant induces the effect.

In an example, the plurality of sensitivities is determined using a Bayesian approach, such as in the step 112 described in FIGS. 1 and 4.

At (S550), at least one candidate surrogate metric can be selected from the candidate surrogate metrics based on the determined plurality of sensitivities.

In an example, the sensitivities of the respective candidate surrogate metrics are ranked and the at least one candidate surrogate metric is selected according to the ranked sensitivities.

Then, the process proceeds to (S599) and terminates.

The method (500) can be suitably adapted. Step(s) in the method (500) can be modified and/or omitted. Additional step(s) can be added. Any suitable order of implementation can be used. In an example, the at least one candidate surrogate metric is used to determine an output of a current controlled testing of the control variant and the treatment variant of the feature of the webpage or the computer application. The output can indicate whether the treatment variant replaces the control variant of the feature of the webpage or the computer application.

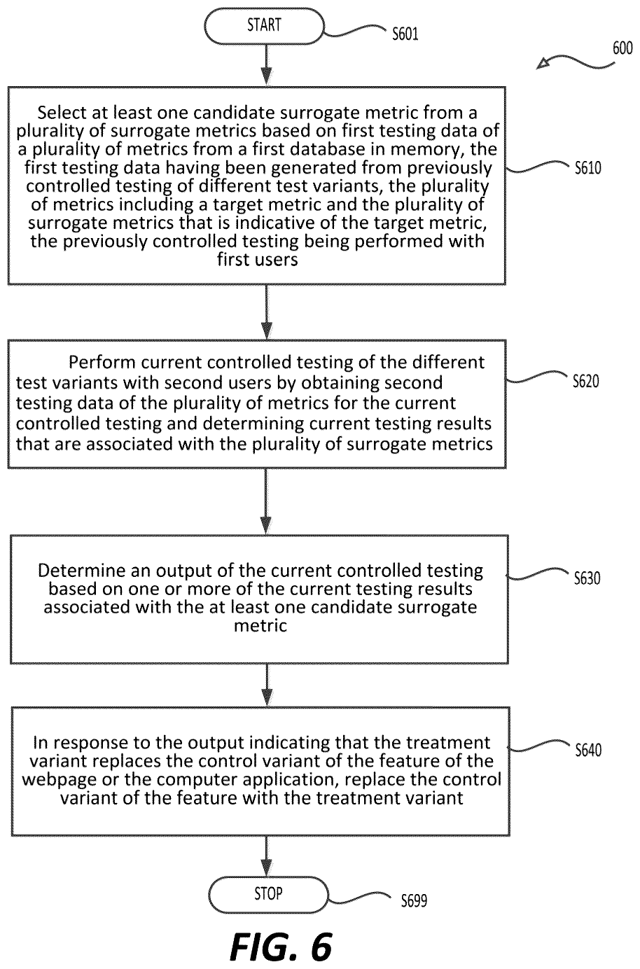

FIG. 6 shows a flow chart outlining a method (600) according to an aspect of the disclosure. The method (600) can be used in an experimental platform. In various aspects, the method (600) is executed by processing circuitry, such as the processing circuitry (101) that performs functions of the experimental platform. In an aspect, the method (600) is implemented in software instructions, thus when the processing circuitry executes the software instructions, the processing circuitry performs the method (600). The process starts at (S601) and proceeds to (S610).

At (S610), at least one candidate surrogate metric from a plurality of surrogate metrics can be selected based on first testing data of a plurality of metrics from a first database in memory, such as described in FIGS. 1, 4, and 5. The first testing data have been generated from previously controlled testing of different test variants, such as described in FIGS. 1, 4, and 5. The plurality of metrics can include a target metric and the plurality of surrogate metrics that is indicative of the target metric. The previously controlled testing can be performed with first users. In an example, the different test variants including a control variant and a treatment variant of a feature of a webpage or a computer application.

At (S620), current controlled testing of the different test variants with second users can be performed by obtaining second testing data (e.g., the current user data from the user data database (132) in FIGS. 1 and 4) of the plurality of metrics for the current controlled testing and determining current testing results that are associated with the plurality of surrogate metrics, such as described in the experiment results computation step (120) in FIGS. 1 and 4. In an example, the second testing data are stored in a second database (e.g., the user data database (132)) in the memory.

At (S630), an output of the current controlled testing can be determined based on one or more of the current testing results associated with the at least one candidate surrogate metric. A subset of the first users can be different from a subset of the second users. In an example, the output of the current controlled testing indicates whether the treatment variant or the control variant is to be used in the feature of the webpage or the computer application (e.g., whether the treatment variant replaces the control variant of the feature of the webpage or the computer application).

At (S640), if the output indicates that the treatment variant replaces the control variant of the feature of the webpage or the computer application, the control variant of the feature of the webpage or the computer application is replaced with the treatment variant.

Then, the process proceeds to (S699) and terminates.

The method (600) can be suitably adapted. Step(s) in the method (600) can be modified and/or omitted. Additional step(s) can be added. Any suitable order of implementation can be used. In an example, the current controlled testing includes A/B testing of the feature of the webpage or the computer application.

The methodologies for measuring metric sensitivities and a computer that implements the methodologies can provide a deeper understanding of why significant metric changes may be absent in controlled experiments, such as described below. That a sensitivity includes two elements: (i) a statistical power and (ii) a movement probability can help distinguish whether an absence of the significant metric changes is due to insufficient statistical power (e.g., the statistical power is relatively small) or a low likelihood of experimental strategies genuinely affecting the metrics (e.g., the movement probability is relatively small). If the absence of the significant metric changes is due to insufficient statistical power, methods (e.g., strategies) to enhance the sensitivity can be deployed. If the absence of the significant metric changes is due to a small movement probability, the method of selecting or identifying sensitive surrogate metrics can serve as an alternative to altering the observed metrics during experiments. When implemented on an experiment platform, the comprehensive framework and methodology and a computer that implements the comprehensive framework and methodology can empower the identification, assessment, and utilization of sensitive surrogate metrics, and thus enhancing decision-making within the context of controlled experiments (e.g., A/B experiments) and addressing the limitations of related technologies.

By implementing sensitive surrogate metrics analysis on experimentation platforms (e.g., implemented with a computer), various benefits that are grounded in empirical evidence and real-world experiments can be obtained. The benefits can include, but are not limited to an enhanced decision-making speed; improved experiment outcome understanding; more informed metric selection; efficient resource allocation; addressing limitations of existing technologies; and the like.

Regarding the enhanced decision-making speed, in some examples, related experimentation platforms primarily provide experimenters with regular experiment results (e.g., shown in the result information (216) in FIGS. 2-3), such as the mean value of the metrics as well as statistical test results that are determined using the step 120 in FIGS. 1 and 4. When the North Star metric does not show a significant change, making product decisions can be difficult no matter how detailed the experiment results are. The methods described in the disclosure can complement this by offering sensitive surrogate metrics analysis results (e.g., shown in the metric information (218) in FIGS. 2-3). The surrogate metrics analysis results can highlight metrics that are both highly correlated with the North Star metrics and sensitive to specific strategic scenarios, and thus enabling faster product decisions, even in cases where significant changes in the North Star metrics are not immediately evident (e.g., if a significant change in a sensitive surrogate metric is immediately evident).

Regarding the improved experiment outcome understanding, the methods described in the disclosure can provide a deeper understanding of experiment outcomes. Highlighting sensitive surrogate metrics that are highly correlated with the North Star metrics, the methods described in the disclosure can offer valuable insights into the factors influencing the primary metric of interest. The improved understanding can enable experimenters to interpret experiment results more effectively and make informed decisions.

Regarding more informed metric selection, through the selection of the at least one candidate surrogate metric based on strong correlations with the North Star metric and the respective sensitivities to specific strategic contexts, the methods described in the disclosure focus on relevant metrics, and thus can result in more informed metric selection and reduce the risk of relying on irrelevant or insensitive metrics in decision-making.

Regarding efficient resource allocation, by assessing the sensitivity of metrics, the methods described in the disclosure can allow experimenters to allocate resources more efficiently. Experimenters can prioritize metrics that are likely to exhibit significant changes under specific strategic scenarios, optimizing resource utilization and experiment efficiency.

The methods described in the disclosure can address the limitations of related technologies, such as the CUPED method, which may not work for new users or may not provide comprehensive information on metric correlations and impact likelihood. By offering a more versatile and informative approach, the methods described in the disclosure effectively overcome the limitations.

As discussed above, the product embodiment of the disclosure can include implementing the sensitive surrogate metrics computation method on an experimentation platform where an experimenter can learn which metrics can be used as sensitive surrogate metrics to the North Star metrics in the experiments and make better product decisions with this additional piece of information. Other alternatives for this technical solution can include the following: (i) implementing the methodology described in the disclosure on other products such as a dashboard with a computation backend and access to database with past experiment data.

The methods described in the disclosure can use any suitable type of database and/or any suitable programming language, as many experiment platforms support variance types of database and/or cloud and programming language. The same methodology can be implemented on a different computational pipeline (e.g., different back-end data pipeline and/or system design)

In the “Selecting Candidate Surrogate Metrics” step (111), ML learning models (e.g., xgboost and random forest) and/or correlation heatmaps can be used to select the candidate surrogate metrics. Further, any suitable models and methods can be used to select the candidate surrogate metrics. For example, correlation analysis can be implemented without using any machine learning models and some candidate surrogate metrics for the North Star metrics may be identified.

Aspects and examples in the disclosure may be used separately or combined in any order. Further, each of the methods (or aspects, examples), an experimental platform, may be implemented using any suitable technique, such as by processing circuitry such as the processing circuitry (101) (e.g., one or more processors or one or more integrated circuits). In one example, the one or more processors execute a program or software instructions that is stored in a computer-readable medium (e.g., a non-transitory computer-readable medium). In an example, a core (740) in a computer system (700) described below includes the processing circuitry (101) or implements functions of the processing circuitry (101) described in the disclosure.

The techniques described above, can be implemented as computer software using computer-readable instructions and physically stored in one or more computer-readable media. For example, FIG. 7 shows the computer system (700) suitable for implementing certain aspects of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system (700) are exemplary in nature and are not intended to suggest any limitation as to the scope of use or functionality of the computer software implementing aspects of the present disclosure. Neither should the configuration of components be interpreted as having any dependency or requirement relating to any one or combination of components illustrated in the exemplary aspect of a computer system (700).

Computer system (700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (701), mouse (702), trackpad (703), touch screen (710), data-glove (not shown), joystick (705), microphone (706), scanner (707), camera (708).

Computer system (700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (710), data-glove (not shown), or joystick (705), but there can also be tactile feedback devices that do not serve as input devices), audio output devices (such as: speakers (709), headphones (not depicted)), visual output devices (such as screens (710) to include CRT screens, LCD screens, plasma screens, OLED screens, each with or without touch-screen input capability, each with or without tactile feedback capability-some of which may be capable to output two dimensional visual output or more than three dimensional output through means such as stereographic output; virtual-reality glasses (not depicted), holographic displays and smoke tanks (not depicted)), and printers (not depicted).

Computer system (700) can also include human accessible storage devices and their associated media such as optical media including CD/DVD ROM/RW (720) with CD/DVD or the like media (721), thumb-drive (722), removable hard drive or solid state drive (723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (700) can also include an interface (754) to one or more communication networks (755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (749) (such as, for example USB ports of the computer system (700)); others are commonly integrated into the core of the computer system (700) by attachment to a system bus as described below (for example Ethernet interface into a PC computer system or cellular network interface into a smartphone computer system). Using any of these networks, computer system (700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (740) of the computer system (700).

The core (740) can include one or more Central Processing Units (CPU) (741), Graphics Processing Units (GPU) (742), specialized programmable processing units in the form of Field Programmable Gate Areas (FPGA) (743), hardware accelerators for certain tasks (744), graphics adapters (750), and so forth. These devices, along with Read-only memory (ROM) (745), Random-access memory (746), internal mass storage such as internal non-user accessible hard drives, SSDs, and the like (747), may be connected through a system bus (748). In some computer systems, the system bus (748) can be accessible in the form of one or more physical plugs to enable extensions by additional CPUs, GPU, and the like. The peripheral devices can be attached either directly to the core's system bus (748), or through a peripheral bus (749). In an example, the screen (710) can be connected to the graphics adapter (750). Architectures for a peripheral bus include PCI, USB, and the like.

CPUs (741), GPUs (742), FPGAs (743), and accelerators (744) can execute certain instructions that, in combination, can make up the aforementioned computer code. That computer code can be stored in ROM (745) or RAM (746). Transitional data can be also be stored in RAM (746), whereas permanent data can be stored for example, in the internal mass storage (747). Fast storage and retrieve to any of the memory devices can be enabled through the use of cache memory, that can be closely associated with one or more CPU (741), GPU (742), mass storage (747), ROM (745), RAM (746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (700), and specifically the core (740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (740) that are of non-transitory nature, such as core-internal mass storage (747) or ROM (745). The software implementing various aspects of the present disclosure can be stored in such devices and executed by core (740). A computer-readable medium can include one or more memory devices or chips, according to particular needs. The software can cause the core (740) and specifically the processors therein (including CPU, GPU, FPGA, and the like) to execute particular processes or particular parts of particular processes described herein, including defining data structures stored in RAM (746) and modifying such data structures according to the processes defined by the software. In addition or as an alternative, the computer system can provide functionality as a result of logic hardwired or otherwise embodied in a circuit (for example: accelerator (744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

Data in this disclosure may include user-related data, for example. User permission or consent needs to be obtained when this embodiment of this application is applied to specific products or technologies, and the collection, use, and processing of related data need to comply with relevant laws, regulations, and standards of relevant countries and regions.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

While this disclosure has described several exemplary aspects, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A computer-implemented method, comprising:
obtaining first testing data of a plurality of metrics from a database in memory, the first testing data having been generated from previously controlled testing of different test variants, the plurality of metrics including a target metric and a plurality of surrogate metrics that is indicative of the target metric, the different test variants including a control variant and a treatment variant of a feature of a webpage or a computer application;
determining, by processing circuitry and based on the first testing data, correlations between each of the plurality of surrogate metrics and the target metric;
determining, by the processing circuitry, candidate surrogate metrics from the plurality of surrogate metrics based on the determined correlations;
determining a plurality of sensitivities of the respective candidate surrogate metrics based on the first testing data, a sensitivity of one of the candidate surrogate metrics indicating a probability that a change of the feature of the webpage or the computer application from the control variant to the treatment variant induces an effect that is detected as a statistically significant change in the one of the candidate surrogate metrics; and
selecting at least one candidate surrogate metric from the candidate surrogate metrics based on the determined plurality of sensitivities, wherein
the at least one candidate surrogate metric is used to determine an output of a current controlled testing of the control variant and the treatment variant of the feature of the webpage or the computer application, and
the output indicates whether the treatment variant replaces the control variant of the feature of the webpage or the computer application.

2. The computer-implemented method of claim 1, wherein the previously controlled testing of the different test variants comprises A/B testing of the control variant and the treatment variant of the feature.

3. The computer-implemented method of claim 1, wherein the determining the correlations comprises:
inputting a subset of the first testing data that is associated with one of the plurality of surrogate metrics and the target metric into a machine learning (ML) model; and
receiving, from the ML model, an output indicating a correlation between the one of the plurality of surrogate metrics and the target metric.

4. The computer-implemented method of claim 1, wherein the correlations between the determined candidate surrogate metrics and the target metric are larger than a correlation threshold.

5. The computer-implemented method of claim 1, wherein the sensitivity of the one of the candidate surrogate metrics is based on:
a statistical power that indicates a conditional probability of detecting the statistically significant change in the one of the candidate surrogate metrics that is conditioned on an alternative hypothesis being true, the alternative hypothesis being true indicating that the change of the feature from the control variant to the treatment variant induces the effect; and
a probability of the alternative hypothesis being true.

6. The computer-implemented method of claim 1, wherein the determining the plurality of sensitivities comprises determining the plurality of sensitivities using a Bayesian approach.

7. The computer-implemented method of claim 1, wherein the selecting the at least one candidate surrogate metric comprises:
ranking the sensitivities of the respective candidate surrogate metrics; and
selecting the at least one candidate surrogate metric according to the ranked sensitivities.

8. The computer-implemented method of claim 1, further comprising:
displaying the selected at least one candidate surrogate metric in a graphical user interface (GUI).

9. A computer-implemented method, comprising:
selecting, by processing circuitry, at least one candidate surrogate metric from a plurality of surrogate metrics based on first testing data of a plurality of metrics from a first database in memory, the first testing data having been generated from previously controlled testing of different test variants, the plurality of metrics including a target metric and the plurality of surrogate metrics that is indicative of the target metric, the previously controlled testing being performed with first users, the different test variants including a control variant and a treatment variant of a feature of a webpage or a computer application;
performing, by the processing circuitry, current controlled testing of the different test variants with second users by
obtaining second testing data of the plurality of metrics for the current controlled testing and storing the second testing data in a second database in the memory, and
determining current testing results that are associated with the plurality of surrogate metrics;
determining an output of the current controlled testing based on one or more of the current testing results associated with the at least one candidate surrogate metric, the output of the current controlled testing indicating whether the treatment variant replaces the control variant of the feature; and
in response to the output indicating that the treatment variant replaces the control variant of the feature of the webpage or the computer application, replacing the control variant of the feature of the webpage or the computer application with the treatment variant.

10. The computer-implemented method of claim 9, wherein the current controlled testing includes A/B testing of the feature of the webpage or the computer application.

11. The computer-implemented method of claim 9, wherein
the method further includes
obtaining the first testing data of the plurality of metrics from the previously controlled testing of the different test variants;
determining, based on the first testing data, correlations between each of the plurality of surrogate metrics and the target metric;
determining candidate surrogate metrics from the plurality of surrogate metrics based on the determined correlations; and
determining a plurality of sensitivities of the respective candidate surrogate metrics based on the first testing data, a sensitivity of one of the candidate surrogate metrics indicating a probability that a change of the feature from the control variant to the treatment variant induces an effect that is detected as a statistically significant change in the one of the candidate surrogate metrics; and
the selecting includes selecting the at least one candidate surrogate metric from the candidate surrogate metrics based on the determined plurality of sensitivities.

12. The computer-implemented method of claim 11, wherein the determining the correlations comprises:
inputting a subset of the first testing data that is associated with one of the plurality of surrogate metrics and the target metric into a machine learning (ML) model; and
receiving, from the ML model, an output indicating a correlation between the one of the plurality of surrogate metrics and the target metric.

13. The computer-implemented method of claim 11, wherein the correlations between the determined candidate surrogate metrics and the target metric are larger than a correlation threshold.

14. The computer-implemented method of claim 11, wherein the sensitivity of the one of the candidate surrogate metrics is based on:
a statistical power that indicates a conditional probability of detecting the statistically significant change in the one of the candidate surrogate metrics that is conditioned on an alternative hypothesis being true, the alternative hypothesis being true indicating that the change of the feature from the control variant to the treatment variant induces the effect; and
a probability of the alternative hypothesis being true.

15. The computer-implemented method of claim 11, wherein the determining the plurality of sensitivities comprises determining the plurality of sensitivities using a Bayesian approach.

16. The computer-implemented method of claim 11, wherein the selecting the at least one candidate surrogate metric comprises:
ranking the sensitivities of the respective candidate surrogate metrics; and
selecting the at least one candidate surrogate metric according to the ranked sensitivities.

17. The computer-implemented method of claim 9, further comprising:
displaying the selected at least one candidate surrogate metric and the output of the current controlled testing in a graphical user interface (GUI).

18. An apparatus, comprising:
processing circuitry configured to:
select at least one candidate surrogate metric from a plurality of surrogate metrics based on first testing data of a plurality of metrics from a first database in memory, the first testing data having been generated from previously controlled testing of different test variants, the plurality of metrics including a target metric and the plurality of surrogate metrics that is indicative of the target metric, the previously controlled testing being performed with first users, the different test variants including a control variant and a treatment variant of a feature of a webpage or a computer application;
perform current controlled testing of the different test variants with second users by
obtaining second testing data of the plurality of metrics for the current controlled testing and storing the second testing data in a second database in the memory, and
determining current testing results that are associated with the plurality of surrogate metrics;
determine an output of the current controlled testing based on one or more of the current testing results associated with the at least one candidate surrogate metric, the output of the current controlled testing indicating whether the treatment variant replaces the control variant of the feature; and
in response to the output indicating that the treatment variant replaces the control variant of the feature of the webpage or the computer application, replace the control variant of the feature of the webpage or the computer application with the treatment variant.

19. The apparatus of claim 18, wherein the current controlled testing includes an A/B testing of the feature of the webpage or the computer application.

20. The apparatus of claim 18, wherein the processing circuitry is configured to:
obtain the first testing data of the plurality of metrics from the previously controlled testing of the different test variants;
determine, based on the first testing data, correlations between each of the plurality of surrogate metrics and the target metric;
determine candidate surrogate metrics from the plurality of surrogate metrics based on the determined correlations;
determine a plurality of sensitivities of the respective candidate surrogate metrics based on the first testing data, a sensitivity of one of the candidate surrogate metrics indicating a probability that a change of the feature from the control variant to the treatment variant induces an effect that is detected as a statistically significant change in the one of the candidate surrogate metrics; and
select the at least one candidate surrogate metric from the candidate surrogate metrics based on the determined plurality of sensitivities.
